(19) United States
(12) Patent Application Publication
(10) Pub. No.: US 2009/0168622 A1
(43) Pub. Date: Jul. 2, 2009

(54) OPTICAL DISK APPARATUS

(75) Inventors: Ryuki SATO, Yokohama-shi (JP); Tatsuji ASHITANI, Yokohama-shi (JP); Takahiko MIHARA, Kawasaki-shi (JP); Yuichi ITO, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/247,808

(22) Filed: Oct. 8, 2008

(30) Foreign Application Priority Data
Dec. 27, 2007 (JP) 2007-337809

(51) Int. Cl. G11B 7/00

(52) U.S. Cl. 369/47.53; G9B/7

(57) ABSTRACT

According to one embodiment, an optical disk apparatus comprises an enable signal generation module configured to generate an enable signal for discriminating a mark and a space in a reproduction signal of an optical disk, a first index calculation module configured to calculate a first evaluation index for evaluating a signal quality of the mark based on a discrimination in accordance with the enable signal and a second index calculation module configured to calculate a second evaluation index for evaluating a signal quality of the space based on the discrimination in accordance with the enable signal.

### CROSS-REFERENCE TO RELATED APPLICATIONS

This application is based upon and claims the benefit of priority from Japanese Patent Application No. 2007-337809, filed Dec. 27, 2007, the entire contents of which are incorporated herein by reference.

### BACKGROUND

1. Field

One embodiment of the present invention relates to an optical disk apparatus capable of discriminating a mark from a space in a reproduction signal to obtain evaluation indexes.

2. Description of the Related Art

In an optical disk apparatus, waveform of a reproduction signal from an optical disk is equalized. An ideal signal is obtained from the waveform-equalized reproduction signal. An error between the ideal signal and the waveform-equalized reproduction signal is called an equalization error. The mean square of the equalization error can be used as an index of reproduction signal quality or reproduction capacity Conventionally, an adjusting method which adjusts various parameters of a laser beam has been proposed to obtain the appropriate mean square of an equalization error.

For example, a reproduction power controlling method is described in Jpn. Pat, Appln. KOKAI Publication No. 2003-16653. According to the method, an error between a current reproduction power and an optimum reproduction power is detected based on amount of equalization resulting from equalization processing, and the reproduction power of a laser beam is controlled so that the error becomes closer to zero.

A recording power or an erase power may be adjusted by a method similar to the above reproduction power controlling so that an equalization error becomes closer to zero. However, in general, the level of a recording power has a significant influence on reproduction quality of a mark, and the level of an erase power has a significant influence on reproduction quality of a space. Therefore, the reproduction quality may not be appropriately evaluated based on a mean square of an equalization error derived from averaging a mark and a space wherein the mark and the space cannot be discriminated from each other. When the reproduction quality is not appropriately evaluated, the recording power and the erase power cannot be appropriately adjusted.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of an optical disk apparatus according to an embodiment of the invention;

FIG. 2 is an exemplary view showing an example of relationship between decode data and enable signals generated according to the decode data;

FIG. 3 is an exemplary view schematically showing examples,of a reproduction signal of a long space formed by applying to a mark a laser beams of different erase powers;

FIG. 4 is an exemplary view showing examples of power adjustment using a mean square of an equalization error; and

FIG. 5 is an exemplary flowchart showing processing of evaluation-index acquisition and power adjustment.

### DETAILED DESCRIPTION

Various embodiments according to the invention will be described hereinafter with reference to the accompanying drawings. In general, according to one embodiment of the invention, an optical disk apparatus comprises an enable signal generation module configured to generate an enable signal for discriminating a mark and a space in a reproduction signal of an optical disk, a first index calculation module configured to calculate a first evaluation index for evaluating a signal quality of the mark based on a discrimination in accordance with the enable signal and a second index calculation module configured to calculate a second evaluation index for evaluating a signal quality of the space based on the discrimination in accordance with the enable signal.

Hereinafter, an explanation will be given on embodiments of an optical disk apparatus according to the invention with reference to the accompanying drawings

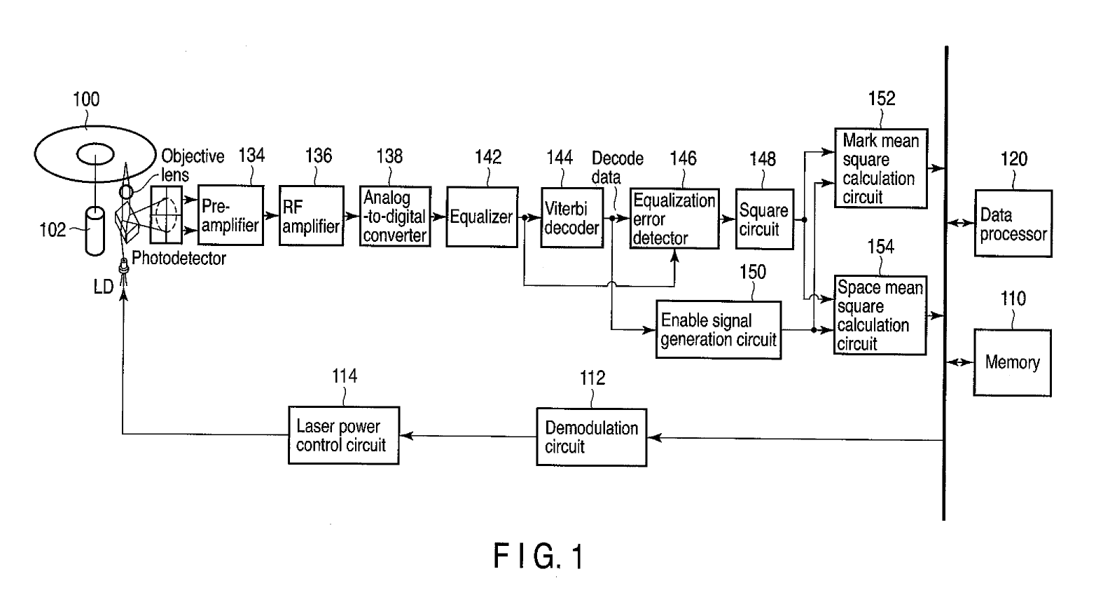

FIG. 1 is an exemplary block diagram showing a configuration of an optical disk apparatus according to an embodiment of the invention. The optical disk apparatus records information on an optical disk 100. The optical disk 100 may include a phase-change optical disk or a rewritable optical disk 100, e.g., HD DVD-RW and HD DVD-RAM. In addition, the optical disk apparatus reads and reproduces the information recorded on the optical disk 100.

A disk motor 102 rotates the optical disk 100. An optical pickup is used to write information on the optical disk 100 and to reproduce information written on the optical disk 100.

To record information on the optical disk 100, the data (recording data) stored in the memory 110 is sent to a modulation circuit 112 and modulated. A laser power control circuit 114 drives a laser diode (LD) according to the modulated recording data to apply a laser beam (recording pulse) to the optical disk 100. The laser beam is applied along a track formed on a recording layer of the optical disk 100 and forms a mark corresponding to the recording data, thereby writes the recording data. A space is a gap between marks. In the optical disk apparatus according to the present embodiment, data is recorded by forming a mark and a space along a track on the optical disk 100. Code length of a mark and a space corresponds to integral multiplication of a reference clock cycle T (e.g., 2T to 11T). The level and pulse width of a recording pulse and fine timing-adjustment information are previously set for each code pattern of the recording data. The laser power control circuit 114 drives the laser diode by a laser driving current for which timing is adjusted based on the fine timing-adjustment information.

Primary levels of the recording pulse output which is used for recording a mark include a recording power and an erase power. When a laser beam of the recording power, which is higher power level, is emitted and the recording layer of the optical disk 100 becomes amorphous, a record mark is formed. The erase power is smaller than the recording power (e.g., approximately half of the recording power). When a laser beam of the erase power is emitted, a mark recorded in advance becomes crystallized and the mark is erased.

To reproduce information recorded on the optical disk 100, a laser beam is applied along a track, and a difference between intensities of lights reflected from a mark and a space on the track is detected. A photo-detector executes photoelectric conversion on the lights reflected from the optical disk 100. Reproduction data subjected to the photoelectric conversion is transmitted through a preamplifier 134 to a radio-frequency (RF) amplifier 136. The reproduction data is amplified to appropriate amplitude and waveform-shaped, then output as an RF signal (reproduction signal). An analog-to-digital converter 138 samples the reproduction signal at a predetermined sampling frequency, and converts the reproduction signal into multiple-valued digital data. A digitized reproduction-signal sequence is demodulated by a digital equalizer 142 and a viterbi decoder based on a Partial Response Maximum Likelihood (PRML) system.

When the digitized reproduction-signal sequence is input to the equalizer 142, the equalizer 142 executes waveform equalization based on partial response (PR) characteristic, which is similar to reproduction-signal characteristics of the optical disk 100. A viterbi decoder 144 decodes each sample of the reproduction-signal sequence, which has been subjected to the waveform-equalization, into original data (decode data). The decode data may be sent to an error correction circuit (not shown) and may be converted to user data.

An equalization error detector 146 generates reference data (ideal reproduction signal) having ideal partial response to each sample of the decode data, and calculates an error between the ideal reproduction signal and the input reproduction signal. This error is called an equalization error. The calculated equalization error is output to a square circuit 148.

The square circuit 148 calculates a square value of each sample of an equalization error. A square-value sequence of equalization error samples of the reproduction-signal sequence calculated by the square circuit 148 is sent to a mark mean-square calculation circuit 152 and a space mean-square calculation circuit 154.

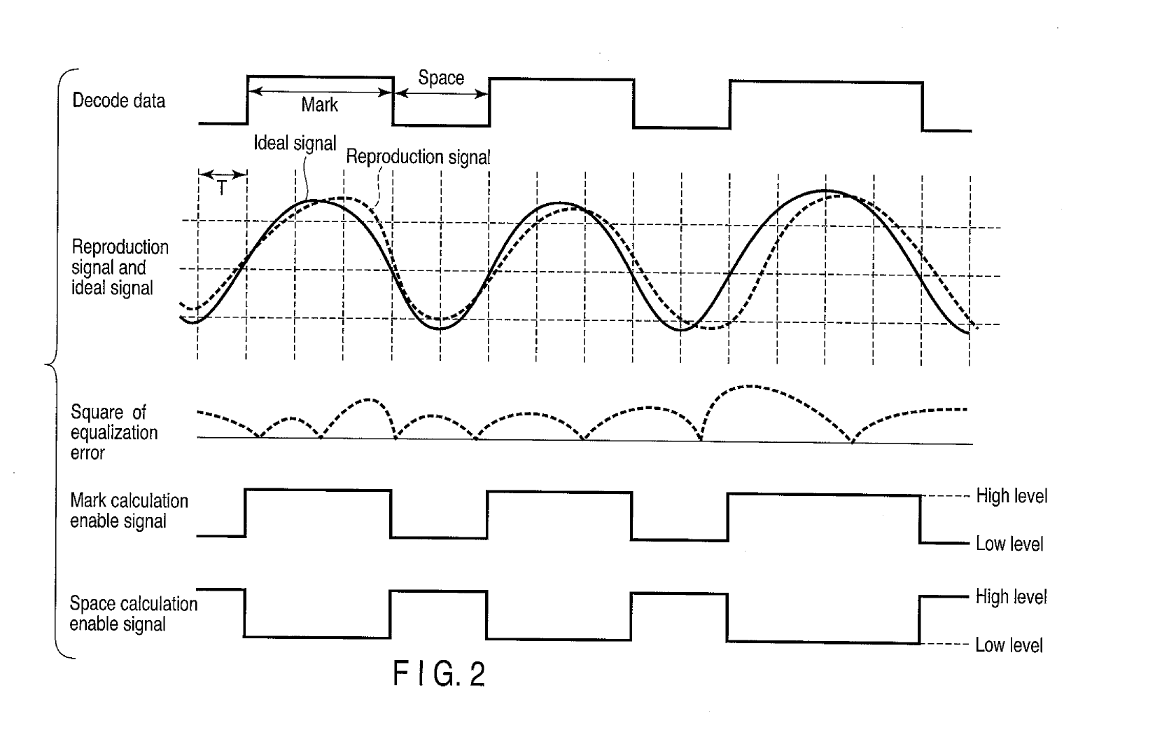

The decode data output from the viterbi decoder 144 is also input to an enable signal generation circuit 150. The enable signal generation circuit 150 generates enable signals shown in FIG. 2, for example, and sends the enable signals to the mark mean-square calculation circuit 152 and the space mean-square calculation circuit 154.

FIG. 2 is an exemplary view showing an example of relationship between the decode data and enable signals generated according to the decode data. As shown in FIG, 2, the enable signal generation circuit 150 sends a high-level enable signal to the mark mean-square calculation circuit 152, and a low-level (or zero) enable signal to the space mean-square calculation circuit 154, as long as the decode data corresponds to a mark. In contrast, as long as the decode data corresponds to a space, the enable signal generation circuit 150 sends a low-level (or zero) enable signal to the mark mean-square calculation circuit 152, and a high-level enable signal to the space mean-square calculation circuit 154.

Each of the mark mean-square calculation circuit 152 and the space mean-square calculation circuit 154 calculates a mean square of samples of an equalization error sent from the square circuit 148, only while receiving input of the high-level enable signal. As an example of an expression which denotes a mean square R of an equalization error n, R=E[n·n] can be used. It should be noted that E[x] indicates an operator for deriving an expectation of x.

A sample of mean square of an equalization error represents distance between an ideal signal and a reproduction signal at a sampling point. A smaller sample of mean square implies that a reproduction signal which is closer to an ideal signal is obtained at the corresponding sampling point. Therefore, a mean square of an equalization error can be used as an index to evaluate quality of a reproduction signal.

The data of a mean square or an equalization error output from the mark mean-square calculation circuit 152 and the data of a mean square output from the space mean-square calculation circuit 154 may be separately stored in a memory 110 accessible from a data processor 120.

In the present embodiment, as above described, squares of samples of an equalization error output from the square circuit 148 can be discriminated according to the decode data, and a mean square of an equalization error of a mark (mark mean square) and a mean square of an equalization error of a space (space mean square) can be separately obtained. That is, an index to evaluate reproduction quality of the mark (mark evaluation index) and an index to evaluate reproduction quality of the space (space evaluation index) can be separately obtained. Therefore, the reproduction qualities of the mark and the space can be evaluated independently from each other.

Next, an explanation will be given on an example of controlling recording waveform by using a mean square of an equalization error of a mark (mark mean square) and a mean square of an equalization error of a space (space mean square) calculated as described above. To overwrite the rewritable optical disk 100 such as a DVD-RW and HD DVD-RAM with information, it is required to erase a previously recorded mark by applying a laser beam of the erase power to the mark. When the erase power is not appropriately set, the mark may not be completely erased.

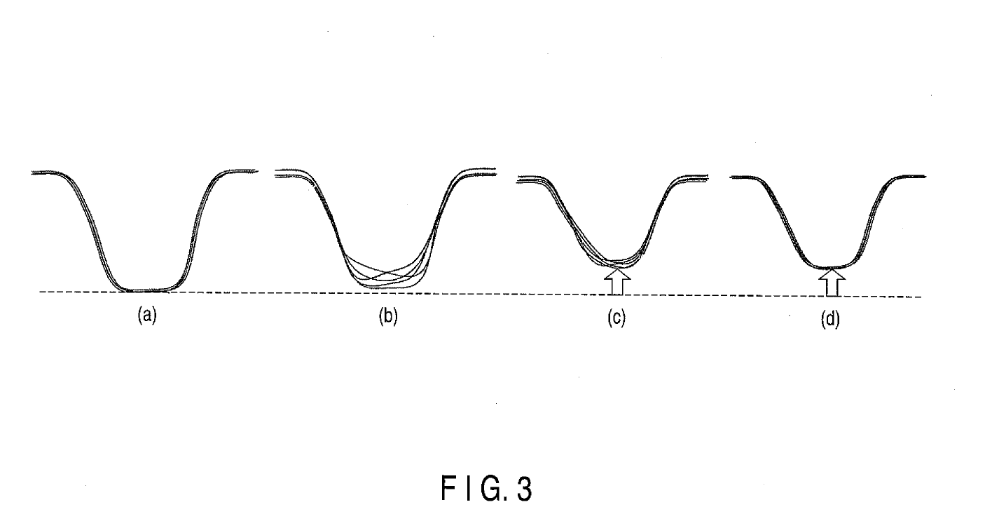

FIG. 3 is an exemplary view schematically showing examples of a reproduction signal of a long space formed by applying to a mark a laser beam of different erase powers.

To erase the recorded mark, it is necessary to crystallize the recording layer again by applying a laser beam of the erase power. When the erase power is appropriately set, the recorded mark is erased and a space is formed as shown in (a) of FIG. 3. However, when the erase power is set lower, the recorded mark is not completely erased as shown in (b) of FIG. 3. When the erase power is set higher, the high erase power even makes the recording layer amorphous as shown in (c) and (d) of FIG. 3. Thus, though the recorded mark is erased, information may be recorded.

The erase power which is inappropriately set results in degradation of a quality of the reproduction signal because of remaining form of a mark or a space which is recorded in advance. Therefore, to overwrite the optical disk, it is necessary to optimize the erase power. In addition, it is also required to set the recording power appropriately.

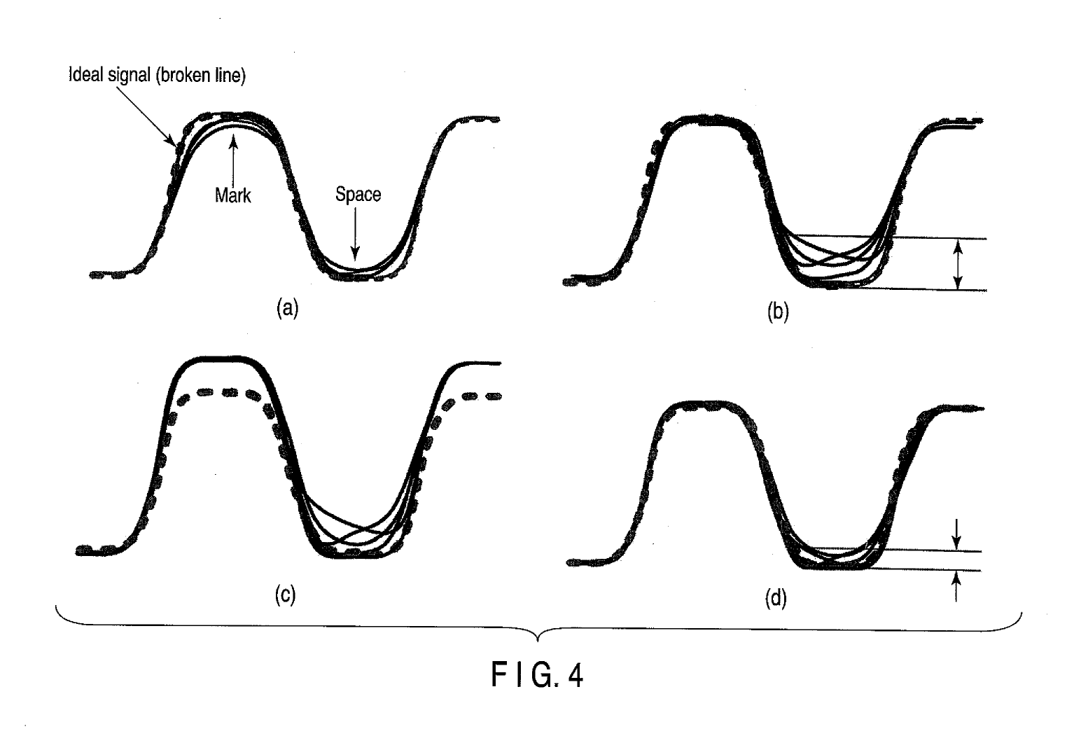

Next, an explanation will be given on a case in which the recording power and the erase power are adjusted using a conventional mean square of an equalization error, in which a mark and a space are not discriminated from each other. FIG. 4 is an exemplary view showing examples of power adjustment using a mean square of an equalization error. In each example shown in FIG. 4, a broken line indicates an ideal signal, and a solid line indicates a reproduction signal.

A case in which an equalization error of a mark is equivalent to an equalization error of a space is shown in (a) of FIG. 4. A case in which the erase power has been insufficient and data which has not been erased remains in the space is shown in (b) of FIG,. 4. A mean square of an equalization error of the whole waveform shown in (a) is equivalent to a mean square of an equalization error of the whole waveform shown in (b) of FIG. 4.

As shown in (a) of FIG. 4, when an equalization error of a mark is equivalent to an equalization error of a space, it is possible to average square values of samples of the equalization error output from the square circuit 138, and to adjust the recording power and the erase power based on the averaged square value (mean square), without distinguishing the mark and the space.

In (b) of FIG. 4, the equalization error of the space is significantly imbalanced in comparison with the equalization error of the mark due to data remaining in the space. In such a case, appropriate power adjustment is difficult.

The difficulty will be explained hereinafter by way of example.

According to a conventional method, when an equalization error is large as shown in (b) of FIG. 4, the recording power is increased. When the recording power is increased, even a mark having a high reproduction quality deviates from the ideal waveform as shown in (c) of FIG. 4, and the reproduction quality is reduced. Further, when gain offset control is performed on waveform to reduce amplitude in the state shown in (c) of FIG. 4, reproduction waveform shown in (d) of FIG. 4 is obtained. In (d) of FIG. 4, amplitude is reduced, and deterioration in the space becomes relatively small.

As a result, the waveform is changed from (b) of FIG. 4 to (d) of FIG. 4 and the mean square of equalization error is certainly decreased; however, the incomplete erasing in the space is not even solved.

When the above adjustment of the recording power continues so that the mean square of equalization error of the whole waveform is reduced, the recording power is continuously increased; thereby the recording power may become overpower which allows re-crystallization of the recording layer.

In the case where the reproduction quality of a space is reduced due to incomplete erasing caused by the insufficient erase power as described above, the power adjustment based on the mean square of equalization error of the whole waveform may cause such erroneous adjustment, namely, increase of the recording power.

As described above, power adjustment based on the mean square of equalization error of the whole waveform including both the mark and the space may reduce the recording quality. Further, such power adjustment requires much time and needs to repeat test recording to obtain an appropriate power. As a result, the available number of overwriting is decreased, and the time for adjustment is increased.

In contrast, in the optical disk apparatus according to the present embodiment, the mark mean-square calculation circuit 152 outputs a mean square of an equalization error of a mark (mark mean square), and the space mean-square calculation circuit 154 outputs a mean square of an equalization error of a space (space mean square). Therefore, an evaluation index indicating reproduction quality of the mark (mark evaluation index) and an evaluation index indicating reproduction quality of the space (space evaluation index) can be separately obtained. Accordingly, the reproduction quality of the mark and the reproduction quality of the space can be independently evaluated.

For example, when the reproduction waveform shown in (b) of FIG. 4 is obtained, the optical disk apparatus according to the present embodiment can recognize that the mark in the reproduction waveform is close to the ideal waveform and the space is deteriorated significantly. It is also possible to determine which of the mark and the space is more deteriorated. Therefore, such adjustment is possible that only the erase power is adjusted to minimize the space mean square without adjusting the recording power.

Furthermore, deterioration of a recording medium caused by repeating overwriting often brings deterioration of a space. Such medium deterioration can also be recognized instantaneously, and solved appropriately by adjusting the erase power.

In contrast to (b) of FIG. 4, even when the mark is close to the ideal waveform but the space is largely deviated from the ideal waveform, the waveform can appropriately be recognized according to the optical disk apparatus of the present embodiment. In such a case, the recording power is adjusted.

The present embodiment allows such adjustment of the recording power and the erase power based on two items of information that the recording power is adjusted based on the mark mean square and the erase power is adjusted based on a space mean square. Therefore, the recording power and the erase power can be determined more appropriately in comparison with adjustment based on a mean square of an equalization error of the whole waveform. Thereby, the recording power and the erase power can be adjusted for various disks, and the recording quality can be improved. As a result, the available number of overwriting is increased, and the time required for power adjustment is reduced.

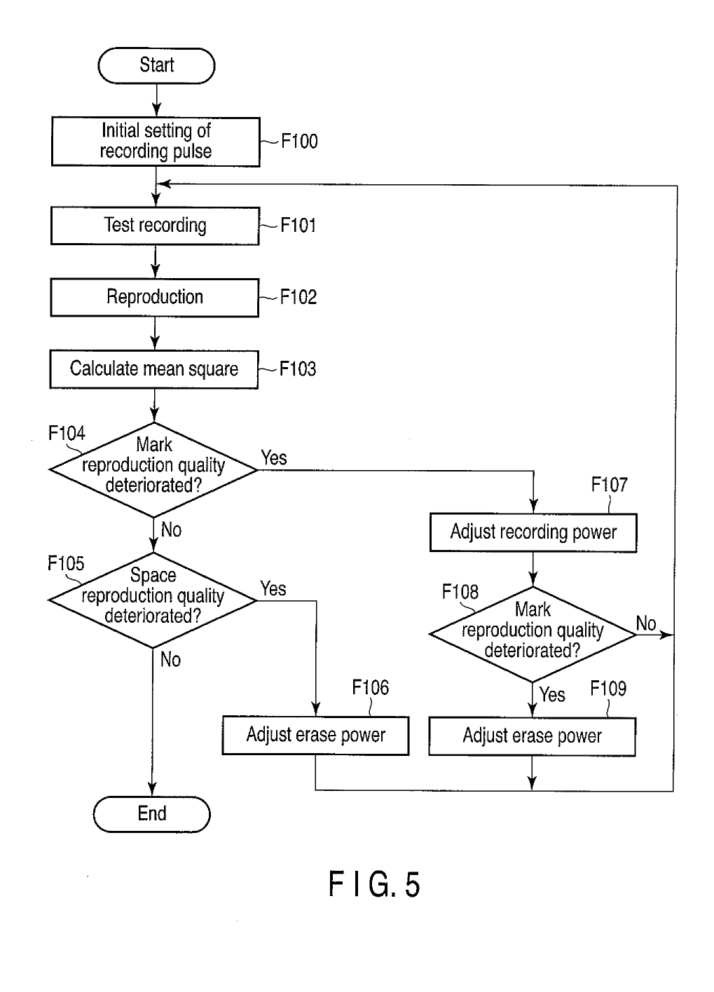

Next, an explanation will be given on acquiring separately the mark evaluation index and the space evaluation index and power adjustment based on the evaluation indexes, according to optical disk apparatus of the present embodiment. FIG. 5 is an exemplary flowchart showing processing acquiring evaluation indexes of a mark and a space having arbitrary code length and power adjustment based on the evaluation indexes. The processing shown in the flowchart of FIG. 5 starts at the time of startup of the optical disk apparatus or the time of ordinary recording of user data. Particularly, at the time of recording of the user data, an optimum power control (OPC) system which automatically adjusts an appropriate laser power while continuing the recording can be used. In the OPC system, before data is actually recorded in a user area, test recording is performed in an OPC area, and then, the data is actually recorded with the recording power and the erase power obtained from the test recording.

When the process shown in FIG. 5 is started, a parameter of a recording pulse is set to a predetermined initial value in the laser power control circuit 114 (block F100). Then, the laser power control circuit 114 drives a laser diode LD based on the set parameter, and performs test recording of random data in a test recording area (or an OPC area) on the optical disk 100 (block F101).

Thereafter, the recorded data is reproduced (block F102). That is, reproduction data subjected to photoelectric conversion by the photo-detector is amplified by the preamplifier 134 and the RF amplifier 136, and converted to a digital signal by the analog-to-digital converter 138. A digitized reproduction-signal sequence is demodulated based on the PRML system by the equalizer 142 and viterbi decoder 144.

Then, a mean square of an equalization error of a mark (mark mean square) and a mean square of an equalization error of a space (space mean square) are calculated (block F103). That is, the equalization error detector 146 calculates an equalization error for each sample of the reproduction-signal sequence and outputs the equalization error to the square circuit 148. The square circuit 148 calculates a square value of each sample of the equalization error. While the mark mean-square calculation circuit 152 is receiving an enable signal of high-level from the enable signal generation circuit 150, the mark mean-square calculation circuit 152 calculates a mean square of samples of the equalization error of a mark. While the space mean-square calculation circuit 154 is receiving an enable signal of high-level from the enable signal generation circuit 150, the space mean-square calculation circuit 154 calculates a mean square of samples of the equalization error of a space.

As described above, a mean square of an equalization error, which is an index for evaluating waveform, can be obtained discriminating a mark from a space. The data of the calculated mark mean square and space mean square may be separately stored in the memory 110 for each code length.

By using the obtained mark evaluation index and the space evaluation index, power of a recording pulse can be adjusted as follows.

It is possible to determine whether the quality of the reproduction signal of the mark having an arbitrary code length is deteriorated or not based on the mark mean square stored as the mark evaluation index in the memory 110 (block F104). That is, the reproduction quality of the mark can be determined. It may be determined whether or not the mark mean square is larger than a given threshold value. When the mark mean value is larger than a given threshold, it is determined that the reproduction quality of the mark is deteriorated. It may be determined whether or not each of samples of the mean square of an equalization error is greater than a predetermined threshold value for the mark having the arbitrary code length. In this case, when the number of samples larger than the predetermined threshold value is more than a given number, it is determined that the reproduction quality of the mark is deteriorated. Or, the sum of the samples may be calculated and it may be determined whether or not the sum is greater than a given threshold. In this case, when the sum is greater than the threshold, it is determined that the reproduction quality of the mark is deteriorated. However, the above are merely examples of quality determination. Any other methods capable of determining the reproduction quality are applicable.

When it is determined that the reproduction signal quality of the mark is not deteriorated (NO in block F104), then it is determined whether the quality of the reproduction signal of the space having the arbitrary code length is deteriorated or not based on the space mean square stored in the memory 110 (block F105). Similarly to determination of the mark quality in block F104, it may be determined whether or not the space mean square is larger than a given threshold. Alternatively, it may be determined each of samples of the mean square of an equalization error is greater than a predetermined threshold value for the space having the arbitrary code length. Or, the sum of the samples is calculated and it may be determined whether or not the sum is greater than a given threshold.

When it is determined that the reproduction signal quality of the space is also not deteriorated (No in block F105), the reproduction qualities of the mark and the space are regarded as high, and the power adjustment process is terminated.

In contrast, when it is determined that the reproduction signal quality of the space is deteriorated (YES in block F105), the erase power is adjusted in order to correct the deterioration (block F106). The adjustment of the erase power is executed so that an equalization error corresponding to the space is reduced. Thereafter, the flow returns to block F101, and test recording may be repeated based on the result of the power adjustment.

When it is determined that the reproduction signal quality of the mark is deteriorated in block F104 (YES in block F104), the recording power is adjusted in order to correct the deterioration (block F107). The adjustment of the recording power is executed so that the equalization error corresponding to the mark is reduced.

After the recording power is adjusted, it may be determined whether or not the reproduction signal quality of the space having the arbitrary code length is deteriorated (block F108). The determination in block F108 relating to the reproduction signal quality of the space is performed similarly to the determination in block F105 relating to the reproduction signal quality of the mark.

When it is determined that the reproduction signal quality of the space is not deteriorated (No in block F108), the space reproduction quality is regarded as high. Thereafter, the flow returns to block F101, and test recording may be repeated based on the result of the power adjustment.

On the other hand, when it is determined that the reproduction signal quality of the space is deteriorated (YES in block F108), the erase power is adjusted in order to correct the deterioration (block F109). The adjustment of the erase power is executed so that the equalization error of the space is reduced. Thereafter, the flow returns to block F101, and test recording may be repeated based on the result of the power adjustment.

According to the above processing, a mean square of an equalization error can be calculated as a quality evaluation index for each of a mark and a space. Reproduction quality of the mark can be evaluated based on a mark evaluation index. Separately from the mark, reproduction quality of the space can be evaluated based on a space evaluation index. Therefore, the recording power and the erase power can be adjusted appropriately and independently of each other.

As shown in FIG. S, the configuration, in which the flow returns to block F101 after the recording power is adjusted (block F107) or the erase power is adjusted (block F106 or F109), allows repeating power adjustment until the recording power and the erase power are set appropriately.

The data used in the test recording in block F101 is not limited to random data. Any test data may be used as required.

In the processing of evaluation-index acquisition and power adjustment shown in FIG. 5, the reproduction quality of the space is evaluated after the recording power is adjusted in block F107. However, the operation may be returned to block F101 without evaluating the reproduction quality of the space. Further, in this power adjustment, the reproduction qualities of both the mark and the space having arbitrary code length are evaluated. However, such configuration is possible if necessary that only the reproduction quality of the mark is evaluated and only the recording power is controlled. Alternatively, such configuration is also possible if necessary that only the reproducing quality of the space is evaluated and only the erase power is controlled.

Alternatively, it may be determined which of the mark and the space is more deteriorated. When the mark is more deteriorated, the recording power may be adjusted. In contrast, when the space is more deteriorated, the erase power may be adjusted.

In the processing of evaluation-index acquisition and power adjustment shown in FIG. 5, evaluation indexes are acquired by the processing from block F100 to block F103, and a power of the recording pulse is adjusted by the processing of block F104 and thereafter. The processing of evaluation-index acquisition (blocks F100 to F103) and the processing of the power adjustment of the recording pulse (block F104 and thereafter) may be separately performed as independent processing.

As described above, according to the optical disk apparatus of the present embodiment, the mark mean square and the space mean square can be separately calculated as evaluation indexes of reproduction qualities; therefore the reproduction qualities of the mark and the space can be separately evaluated.

Accordingly, erroneous adjustment, e.g., adjustment of the recording power when the space is deteriorated, can be prevented. Further, adjusting the recording power based on the evaluation of the reproduction quality of the mark and adjusting the erase power based on the evaluation of the reproduction quality of the space allows appropriate power adjustment. For example, even when the erase power is small and a mark is not completely erased, the erase power can be appropriately adjusted.

As an expression of a mean square R of an equalization error of a reproduction signal, which is used as an evaluation index, R=E[n·n] is used by way of example. However, a method of obtaining a mean square is not limited to this. An arithmetic mean, a geometric mean or a time mean may be used,

An evaluation index other than the mean square of the equalization error may be used for evaluating a reproduction signal quality. For example, the recording power may be adjusted by optimizing a symmetry (β) and a modulation degree (γ). The symmetry and the modulation degree indicate the simplified quality of signal waveform such as a mean square of an equalization error.

Further, a mark and a space can be separately evaluated by using jitter, partial response signal-to-noise ratio (PRSNR), simulated bit error rate (SbER), etc., instead of a mean square of an equalization error.

The jitter is an index for evaluating variation in the timing that a reproduction signal passes a threshold for binary conversion. When the jitter is used as an evaluation index, unevenness of a reproduction signal in time with reference to a reproduction clock can be evaluated.

The PRSNR is used as an index for evaluating a signal-to-noise ratio and linearity in the PRML system. The SbER is an evaluation index for estimating a bit error rate without using recording data.

Concomitant use of the above evaluation indexes allows more explicit evaluation of the reproduction signal quality.

Further, generating an enable signal in accordance with the center of a long mark or a short mark, not according to the amplitude of decode data, eliminates the influence of intersymbol interference between shorter marks.

As explained herein, according to the present embodiment, an equalization error that is an error between a decoded reproduction signal and an ideal signal is used as an index for evaluating the quality of the reproduction signal. The enable signal generation circuit 150 sends a high-level enable signal to the mark mean-square calculation circuit 152, while the decode data is corresponding to a mark, and sends a high level enable signal to the space mean-square calculation circuit 154, while the decode data is corresponding to a space. Therefore, while the mark mean-square calculation circuit 152 is receiving a high-level enable signal, a mean square of an equalization error of the mark is calculated as an index for evaluating the mark. While the space mean-square calculation circuit 154 is receiving a high-level enable signal, a mean square of an equalization error of the space is calculated as an index for evaluating the space. Therefore, evaluation indexes for the mark and the space can be separately obtained based on the enable signal generated from the enable signal generation circuit 150.

Further, a recording power can be adjusted according to the mark evaluation index, and an erase power can be controlled according to the space evaluation index. Therefore, accuracy of adjusting a recording pulse can be increased, and the quality of recording is improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules, or components on one or more computers, such as servers. While the various modules are illustrated separately, they may share some or all of the same underlying logic or code.

What is claimed is:

1. An optical disk apparatus comprising;
an enable signal generation module configured to generate an enable signal for discriminating a mark and a space in a reproduction signal of an optical disk;
a first index calculation module configured to calculate a first evaluation index for evaluating a signal quality of the mark based on a discrimination in accordance with the enable signal; and
a second index calculation module configured to calculate a second evaluation index for evaluating a signal quality of the space based on the discrimination in accordance with the enable signal.

2. The optical disk apparatus of claim 1, further comprising:
a signal decode module configured to decode the reproduction signal of the optical disk and to output a decode signal;
an ideal signal generation module configured to generate an ideal signal corresponding to the decode signal; and
an error detection module configured to detect an error between the decode signal and the ideal signal.

3. The optical disk apparatus of claim 2, wherein
the first index calculation module is configured to calculate a mean square of an error corresponding to the mark detected by the error detection module as the first evaluation index; and
the second index calculation module is configured to calculate a mean square of an error corresponding to the space detected by the error detection module as the second evaluation index.

4. The optical disk apparatus of claim 2, wherein the enable signal generation module is configured to generate the enable signal for discriminating the mark and the space based on a level of the decode signal.

5. The optical disk apparatus of claim 4, wherein the enable signal generation module is configured to generate the enable signal causing the first evaluation index calculation module to calculate the first evaluation index while the decode signal keeps a first level and causing the second evaluation index calculation module to calculate the second evaluation index while the decode signal keeps a second level.

6. The optical disk apparatus of claim 5, wherein the enable signal generation module is configured to output the enable signal to the first evaluation index calculation module while the decode signal corresponds to the mark, and outputs the enable signal to the second evaluation index calculation module while the decode signal corresponds to the space.

7. The optical disk apparatus of claim 1, further comprising a recording pulse adjustment module configured to adjust a recording pulse based on the first evaluation index and the second evaluation index.

8. The optical disk apparatus of claim 7, wherein the recording pulse adjustment module is configured to adjust an erase power of the recording pulse based on the second evaluation index.

9. The optical disk apparatus of claim 7, wherein the recording pulse adjustment module adjust a recording power of the recording pulse based on the first evaluation index.

10. An evaluation index calculation method comprising:
generating an enable signal for discriminating a mark and a space in a reproduction signal of an optical disk;
calculating a first evaluation index for evaluating a signal quality of the mark based on discrimination in accordance with the enable signal; and
calculating a second evaluation index for evaluating a signal quality of the space based on the discrimination in accordance with the enable signal.

11. The evaluation index calculation method of claim 10, further comprising:
decoding the reproduction signal of the optical disk and outputting a decode signal;
generating an ideal signal corresponding to the decode signal;
detecting an error between the decode signal and the ideal signal;
calculating the first evaluation index based on an error corresponding to the mark; and
calculating the second evaluation index based on an error corresponding to the space.

12. The evaluation index calculation method of claim 11, wherein
a mean square of the error corresponding to the mark is calculated as the first evaluation index, and
a mean square of the error corresponding to the space is calculated as the second evaluation index.

13. The evaluation index calculation method of claim 12, wherein the enable signal is generated based on a level of the decode signal.

14. The evaluation index calculation method of claim 12, wherein the enable signal is generated so that the first evaluation index is calculated while the decode signal keeps a first level and the second evaluation index is calculated while the decode signal keeps a second level.

15. The evaluation index calculation method of claim 14, wherein the enable signal is generated so that the first evaluation index is calculated while the decode signal corresponds the mark, and the second evaluation index is calculated while the decode signal corresponds to the space.

16. A recording pulse adjusting method comprising:
generating an enable signal for discriminating a mark and a space in a reproduction signal of an optical disk;
calculating a first evaluation index for evaluating a signal quality of the mark based on discrimination in accordance with the enable signal;
calculating a second evaluation index for evaluating a signal quality of the space based on the discrimination in accordance with the enable signal; and
adjusting setting of a recording pulse based on the first evaluation index and the second evaluation index.

17. The recording pulse adjusting method of claim 16, wherein an erase power of the recording pulse is adjusted based on the second evaluation index.

18. The recording pulse adjusting method of claim 16, wherein a recording power of the recording pulse is adjusted based on the first evaluation index.

19. The recording pulse adjusting method of claim 16, wherein
a mean square of an error corresponding to the mark is calculated as the first evaluation index, and
a mean square of an error corresponding to the space is calculated as the second evaluation index.

20. The recording pulse adjusting method of claim 16, wherein the enable signal is generated based on a level of the decode signal.
